(19) United States
(12) Patent Application Publication
(10) Pub. No.: US 2025/0356455 A1
(43) Pub. Date: Nov. 20, 2025

(54) Controllable Video Frame Interpolation with Latent Blending and Motion Alignment

(71) Applicants: Disney Enterprises, Inc., Burbank, CA (US); ETH Zurich (EIDGENOSSISCHETECHNISCHE HOCHSCHULE ZURICH), Zurich (CH)

(72) Inventors: Abdelaziz Djelouah, Zurich (CH); Karlis Martins Briedis, Zurich (CH); Christopher Richard Schroers, Uster (CH); Raphael Francois Ortiz, Dübendorf (CH)

(21) Appl. No.: 19/059,872

(22) Filed: Feb. 21, 2025

Related U.S. Application Data
(60) Provisional application No. 63/647,851, filed on May 15, 2024.

(51) Int. Cl. G06T 3/4007; G06T 3/18; G06T 7/246; G06T 7/73

(52) U.S. Cl. CPC G06T 3/4007; G06T 3/18; G06T 7/248; G06T 7/74

(57) ABSTRACT

A system includes a processor and a memory storing software code including a video frame interpolation machine-learning (ML) model. The processor executes the software code to receive an input video sequence including a first video frame and a second video frame, obtain point tracks between the first video frame and the second video frame, identify a target position for an interpolated video frame and determine, using the point tracks, a first optical flow between the target position and the first video frame, and a second optical flow between the target position and the second video frame. The processor further executes the software code to warp, using the first optical flow and the second optical flow, respectively, the first video frame and the second video frame, respectively, and predict, using the video frame interpolation ML model, the warped first video frame and the warped second video frame, the interpolated video frame.

### RELATED APPLICATIONS

The present application claims the benefit of and priority to pending Provisional Patent Application Ser. No. 63/647,851 filed on May 15, 2024, and titled “Controllable Video Frame Interpolation with Latent Blending and Motion Alignment,” which is hereby incorporated fully by reference into the present application.

### BACKGROUND

Video frame interpolation is a commonly used post-processing technique that can be used for frame rate adjustment, novel-view synthesis and the generation of artistic slow-motion effects, for example. Although advances in video frame interpolation made in recent years have significantly improved the quality of interpolated frames, finding correspondences for large displacements between keyframes and compensating for that motion remains a challenging problem. Moreover, because video frame interpolation is an ill-posed problem, it can result in generation of plausible intermediate frames that can differ disturbingly from user expectations. Nevertheless, to date little research has been directed to solutions for controlling interpolated outputs. Thus, there remains a need in the art for a video frame interpolation solution that is both controllable and provides motion alignment.

### BRIEF DESCRIPTION OF THE DRAWINGS

FIG. 1 shows a system for performing controllable video frame interpolation with latent blending and motion alignment, according to one implementation;

FIG. 2 illustrates an overview of a process for performing controllable video frame interpolation with latent blending and motion alignment, according to one implementation;

FIG. 3 shows a flowchart presenting an exemplary method for performing controllable video frame interpolation with latent blending and motion alignment, according to one implementation

FIG. 4 shows a diagram of an exemplary timestep-aware synthesis network suitable for use by the system shown in FIG. 1, according to one implementation; and

FIG. 5 shows an approach to enabling motion alignment for non-linear motion between video frames, according to one implementation.

### DETAILED DESCRIPTION

The following description contains specific information pertaining to implementations in the present disclosure. One skilled in the art will recognize that the present disclosure may be implemented in a manner different from that specifically discussed herein. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

As noted above, video frame interpolation is a commonly used post-processing technique that can be used for frame rate adjustment, novel-view synthesis and the generation of artistic slow-motion effects, for example. Although advances in video frame interpolation made in recent years have significantly improved the quality of interpolated frames, finding correspondences for large displacements between keyframes and compensating for that motion remains a challenging problem. Moreover, because video frame interpolation is an ill-posed problem, it can result in generation of plausible intermediate frames that can differ disturbingly from user expectations. Nevertheless, and as also noted above, to date little research has been directed to solutions for controlling interpolated outputs.

The present application discloses systems and methods for performing controllable video frame interpolation with latent blending and motion alignment that address overcome the deficiencies in the conventional art. The disclosure provided in the present application connects point tracking with non-linear motion estimation and motion controllability to introduce a novel and inventive tracking-based video frame interpolation system and method. In addition, a plurality of augmentation techniques are disclosed that can be applied to the present video frame interpolation solution, as well as to conventional video frame interpolation methods. Those augmentation techniques may be used to improve the training performed in conventional video frame interpolation methods, to add elements of control making those conventional methods more usable for practical applications in the industry, and to enable the analysis of non-linearities that are present in the commonly used datasets and address the impact those non-linearities have when training is performed on uncurated video data. Although the focus of the present disclosure is on controllability that is hard to measure with quantitative metrics, it is also shown that using control values extracted from the ground truth can significantly improve interpolated video frame reconstruction.

The video frame interpolation solution disclosed by the present application advances the state-of-the-art in several ways. For example, the present video frame interpolation approach is a tracking-based interpolation approach that utilizes sparse correspondences between video frames and performs timestep-dependent frame blending to control how much the appearance of each input video frame affects the interpolated video frame. In addition, motion-aligned training adjusts a machine learning (ML) model to better handle non-linear motion in the training data, resulting in improvement in the sharpness of the interpolated video frames and the ability of the trained ML model to perform non-linear motion interpolation while training only with frame triplets. Further advantages of the present solution include low-rank synthesis adaptation that enables sharpness adjustment during inference and also enables spatially-variable user control, the use of user-specified keyframe correspondences that allow a system user to assist the motion estimation ML model by providing it with correct matches, and enabling user control for specifying motion curves thereby allowing system users to control where objects appear in the interpolated video frame. Furthermore, it is noted that although the present video frame interpolation solution enables several user controls, as described above, in some use cases the present solution can be implemented as substantially automated systems and methods.

It is further noted that, as used in the present application, the terms “automation,” “automated” and “automating” refer to systems and processes that do not require the participation of a human user. Although, in some implementations, a human system user may control aspects of the performance of the systems operating according to the processes described herein, that human involvement is optional. Thus, in some use cases the processes described in the present application may be performed under the control of hardware processing components of the disclosed systems.

It is also noted that the present approach implements one or more trained video frame interpolation ML models (hereinafter “video frame interpolation ML model(s)”), which, once trained, are very efficient, and can provide interpolated video frames quickly, accurately and efficiently. Moreover, the complexity involved in performing the video frame interpolations disclosed in the present application requires the use of such video frame interpolation ML model(s) because human performance of the present video frame interpolation solution is impossible, even with the assistance of the processing and memory resources of a general purpose computer.

As defined in the present application, the expression “ML model” refers to a computational model for making predictions based on patterns learned from samples of data or training data. Various learning algorithms can be used to map correlations between input data and output data. These correlations form the computational model and can be used to make future predictions on new input data. Such a predictive model may include one or more logistic regression models, Bayesian models, artificial neural networks (NNs) such as Transformers, large language models (LLMs), or multimodal foundation models, to name a few examples. In various implementations, ML models may be trained as classifiers and may be utilized to perform image processing, audio processing, natural-language processing, and other inferential analyses. A “deep neural network,” in the context of deep learning, may refer to a NN that utilizes multiple hidden layers between input and output layers, which may allow for learning based on features not explicitly defined in raw data. As used in the present application, a feature identified as a NN refers to a deep neural network.

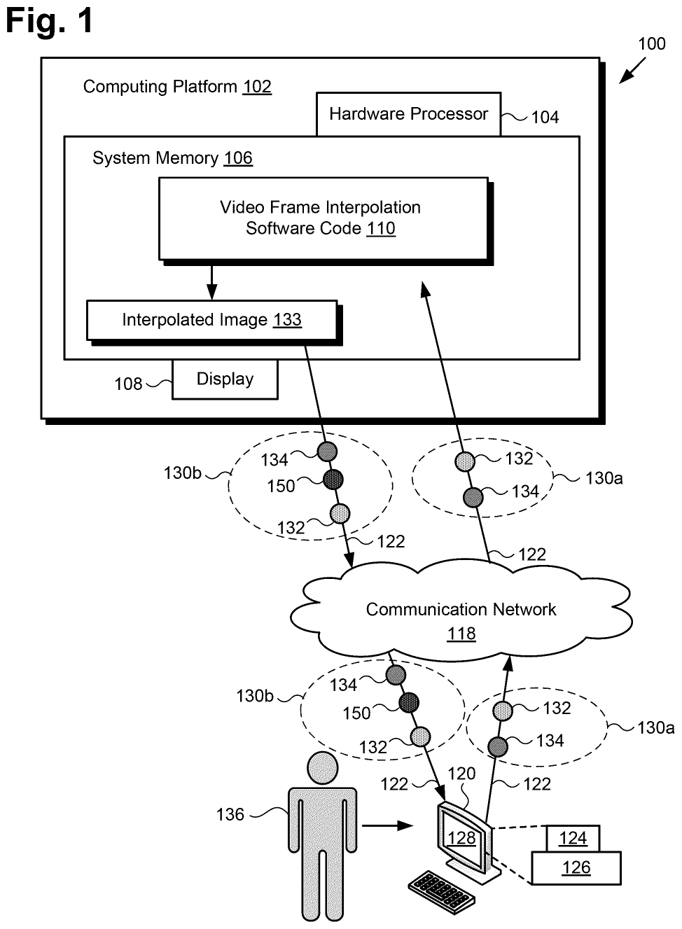

FIG. 1 shows system 100 for performing controllable video frame interpolation with latent blending and motion alignment, according to one implementation. As shown in FIG. 1, system 100 includes computing platform 102 having hardware processor 104, system memory 106 implemented as a computer-readable non-transitory storage medium, and display 108. According to the present exemplary implementation, system memory 106 stores video frame interpolation software code 110.

As further shown in FIG. 1, system 100 is implemented within a use environment including communication network 118, user system 120 including user system hardware processor 124, user system memory 126, and display 128, as well as system user 136 utilizing user system 120. It is noted that display 108 of system 100, as well as display 128 of user system 120, may be implemented as a liquid crystal display (LCD), a light-emitting diode (LED) display, an organic light-emitting diode (OLED) display, a quantum dot (QD) display or any other suitable display screen that performs a physical transformation of signals to light.

FIG. 1 further shows network communication links 122 interactively connecting user system 120 and system 100 via communication network 118, input video sequence 130a including first and second video frames 132 and 134, which may be consecutive rendered video frames in the original content of input video sequence 130a. Also shown in FIG. 1 is output video sequence 130b including first and second video frames 132 and 134, and interpolated video frame 150 produced using video frame interpolation software code 110 and inserted between first and second video frames 132 and 134.

It is noted that video sequences 130a and 130b may contain any of a variety of different types and genres of audio-video (AV) content, as well as video unaccompanied by audio. Specific examples of AV content include content in the form of movies, TV episodes or series, podcasts, streaming or other web-based content, video games, and sporting events. In addition, or alternatively, in some implementations, content carried by video sequences 130a and 130b may be or include digital representations of persons, fictional characters, locations, objects, and identifiers such as brands and logos, for example, which populate a virtual reality (VR), augmented reality (AR), or mixed reality (MR) environment. Moreover, that content may depict virtual worlds that can be experienced by any number of users synchronously and persistently, while providing continuity of data such as personal identity, user history, entitlements, possessions, payments, and the like. It is noted that the concepts disclosed by the present application may also be applied to content that is a hybrid of traditional AV and fully immersive VR/AR/MR experiences, such as interactive video.

Although the present application refers to video frame interpolation software code 110 as being stored in system memory 106 for conceptual clarity, more generally system memory 106 may take the form of any computer-readable non-transitory storage medium. The expression “computer-readable non-transitory storage medium,” as used in the present application, refers to any medium, excluding a carrier wave or other transitory signal that provides instructions to hardware processor 104 of computing platform 102. Thus, a computer-readable non-transitory storage medium may correspond to various types of media, such as volatile media and non-volatile media, for example. Volatile media may include dynamic memory, such as dynamic random access memory (dynamic RAM), while non-volatile memory may include optical, magnetic, or electrostatic storage devices. Common forms of computer-readable non-transitory storage media include, for example, internal and external hard drives, optical discs, RAM, programmable read-only memory (PROM), erasable PROM (EPROM) and FLASH memory.

Moreover, in some implementations, system 100 may utilize a decentralized secure digital ledger in addition to system memory 106. Examples of such decentralized secure digital ledgers may include a blockchain, hashgraph, directed acyclic graph (DAG), and Holochain® ledger, to name a few. In use cases in which the decentralized secure digital ledger is a blockchain ledger, it may be advantageous or desirable for the decentralized secure digital ledger to utilize a consensus mechanism having a proof-of-stake (POS) protocol, rather than the more energy intensive proof-of-work (PoW) protocol.

Although FIG. 1 depicts video frame interpolation software code 110 as being stored in its entirety in system memory 106, that representation is also provided merely as an aid to conceptual clarity. More generally, system 100 may include one or more computing platforms 102, such as computer servers for example, which may be co-located, or may form an interactively linked but distributed system, such as a cloud-based system, for instance. As a result, hardware processor 104 and system memory 106 may correspond to distributed processor and memory resources within system 100.

Hardware processor 104 may include a plurality of hardware processing units, such as one or more central processing units, one or more graphics processing units, and one or more tensor processing units, one or more field-programmable gate arrays (FPGAs), custom hardware for machine-learning training or inferencing, and an application programming interface (API) server, for example. By way of definition, as used in the present application, the terms “central processing unit” (CPU), “graphics processing unit” (GPU), and “tensor processing unit” (TPU) have their customary meaning in the art. That is to say, a CPU includes an Arithmetic Logic Unit (ALU) for carrying out the arithmetic and logical operations of computing platform 102, as well as a Control Unit (CU) for retrieving programs, such as software code 110, from system memory 106, while a GPU may be implemented to reduce the processing overhead of the CPU by performing computationally intensive graphics or other processing tasks. A TPU is an application-specific integrated circuit (ASIC) configured specifically for artificial intelligence processes such as machine learning.

According to the implementation shown by FIG. 1, system user 136 may utilize user system 120 to interact with computing platform 102 of system 100 over communication network 118. In some implementations, computing platform 102 may correspond to one or more web servers, accessible over a packet-switched network such as the Internet, for example. Alternatively, computing platform 102 may correspond to one or more computer servers supporting a private wide area network (WAN), local area network (LAN), or included in another type of limited distribution or private network. In addition, or alternatively, in some implementations, system 100 may utilize a local area broadcast method, such as User Datagram Protocol (UDP) or Bluetooth®, for instance. Furthermore, in some implementations, system 100 may be implemented virtually, such as in a data center. For example, in some implementations, system 100 may be implemented in software, or as virtual machines. Moreover, in some implementations, communication network 118 may be a high-speed network suitable for high performance computing (HPC), for example a 10 GigE network or an Infiniband network.

Although user system 120 is shown as a desktop computer in FIG. 1, that representation is provided merely as an example. More generally, user system 120 may be any suitable mobile or stationary computing device or system that implements data processing capabilities sufficient to provide a user interface, support connections to communication network 118, and implement the functionality ascribed to user system 120 herein. For example, in some implementations, user system 120 may take the form of a laptop computer, tablet computer, smartphone, game console, or an AR or VR headset, glasses, or other type of AR or VR device for example. However, in other implementations user system 120 may be a “dumb terminal” peripheral component of system 100 that enables system user 136 to provide inputs via a keyboard or other input device, as well as to view video content via display 128. In those implementations, user system 120 and display 128 may be controlled by hardware processor 104 of system 100.

With respect to display 128 of user system 120, display 128 may be physically integrated with user system 120 or may be communicatively coupled to but physically separate from user system 120. For example, where user system 120 is implemented as a smartphone, laptop computer, tablet computer, or AR or VR device, display 128 will typically be integrated with user system 120. By contrast, where user system 120 is implemented as a desktop computer, display 128 may take the form of a monitor separate from user system 120 in the form of a computer tower.

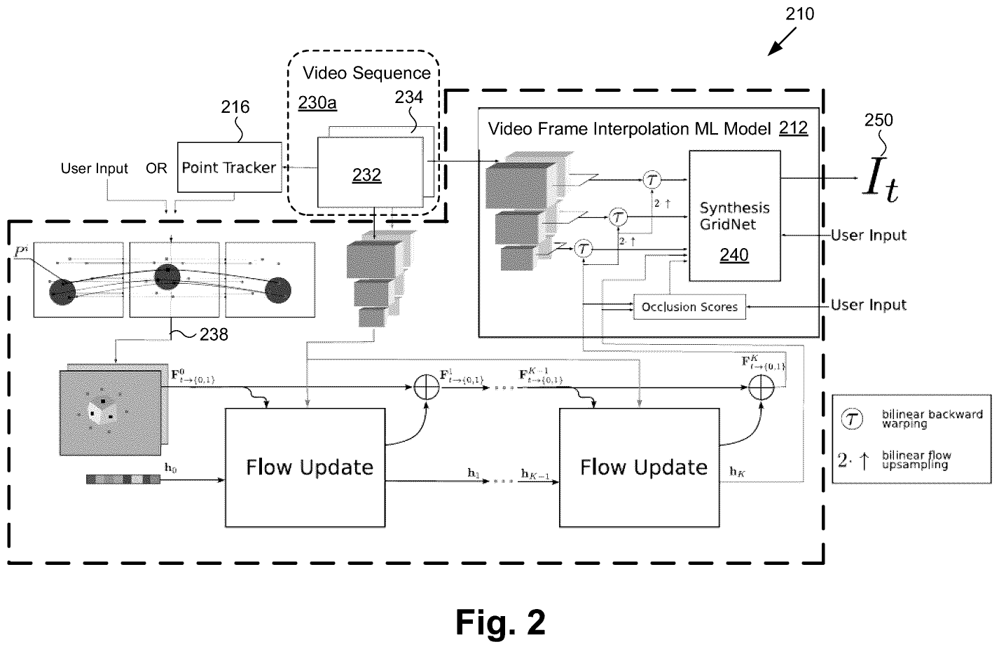

FIG. 2 illustrates an overview of a process for performing controllable video frame interpolation with latent blending and motion alignment, according to one implementation. As shown in FIG. 2, video frame interpolation software code 210 receives input video sequence 230a including first and second video frames 232 and 234, and predicts interpolated video frame 250 for insertion between first and second video frames 232 and 234. Also shown in FIG. 2 are plurality of point tracks 238 from first video frame 232 to second video frame 234, video frame interpolation ML model 212 of video frame interpolation software code 210 including synthesis GridNet 240. It is noted that, in some implementations, video frame interpolation software code 210 may also include optional point tracker software 216.

It is further noted that video frame interpolation software code 210, input video sequence 230a including first and second video frames 232 and 234, and interpolated video frame 250 correspond respectively in general to video frame interpolation software code 110, input video sequence 130a including first and second video frames 132 and 134, and interpolated video frame 150, in FIG. 1. Consequently, video frame interpolation software code 110, input video sequence 130a including first and second video frames 132 and 134, and interpolated video frame 150 may share any of the characteristics attributed to respective video frame interpolation software code 210, input video sequence 230a including first and second video frames 232 and 234, and interpolated video frame 250 by the present disclosure, and vice versa. Thus, although not shown in FIG. 1, like video frame interpolation software code 210, video frame interpolation software code 110 may include video frame interpolation ML model 212 including synthesis GridNet 240, may further include optional point tracker software 216, and may be configured to process plurality of point tracks 238.

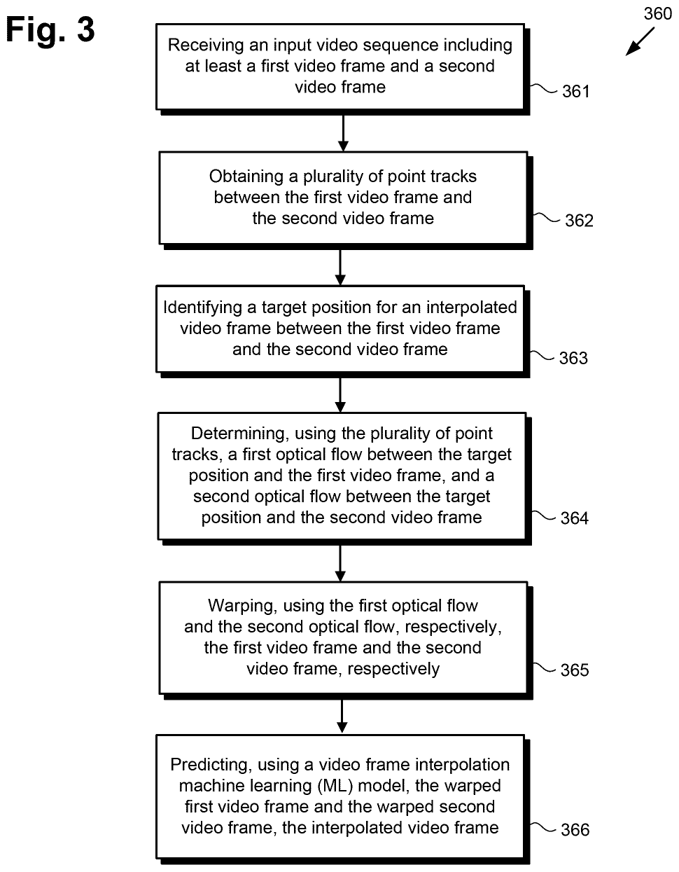

The process depicted in FIG. 2 is described in greater detail below by reference to FIG. 3. By way of overview, The goal of video frame interpolation is to reconstruct a frame Iₜ given two or more neighboring frames Iᵢ, i ∈{ . . . , 0, 1, . . . } such that it is a plausible, motion-compensated, t-weighted combination between I₀ and I₁. To that end, plurality of point tracks 238 from first video frame 232 to second video frame 234 are obtained, either as inputs from system user 136, in FIG. 1, or by being determined using optional point tracker software 216 of video frame interpolation software code 110/210. Plurality of point tracks 238 are used to compute optical flows to first and second video frames 132/232 and 134/234 at a target position between first and second video frames 132/232 and 134/234 for insertion of interpolated video frame 150/250. In some implementations, those computed optical flows may be refined by applying one or more iterations of flow update steps. The computed or refined optical flows are then used to warp first and second video frames 132/232 and 134/234, through backward warping or forward warping for example, and to synthesize interpolated video frame 150/250.

The functionality of system 100 and video frame interpolation software code 110/210 will be further described by reference to FIG. 3. FIG. 3 show flowchart 360 presenting an exemplary method for performing controllable video frame interpolation with latent blending and motion alignment, according to one implementation. With respect to the method outlined in FIG. 3, it is noted that certain details and features have been left out of flowchart 360 in order not to obscure the discussion of the inventive features in the present application.

Referring now to FIG. 3 in combination with FIGS. 1 and 2, flowchart 360 includes receiving input video sequence 130a/230a including at least first video frame 132/232 and second video frame 134/234 (action 361). As shown in FIG. 1, input video sequence 130a/230a may be received from user system 120 via communication network 118 and network communication links, in action 361, by video frame interpolation software code 110/210, executed by hardware processor 104 of system 100.

Continuing to refer to FIGS. 1, 2 and 3 in combination, flowchart 360 further includes obtaining plurality of point tracks 238 between first video frame 132/232 and second video frame 134/234 (action 362). It is noted that one, some, or all of plurality of point tracks 238 may be sparse point tracks having a few hundred points, up to one thousand points, for instance. By way of example, plurality of point tracks 238 may include an integer number L of point tracks, such that the i-th point track

$${P}^{i} = \{ ( {x}_{j}^{i} , {v}_{j}^{i} ) \vert j ∈ N \}$$

contains the position x of the same three-dimensional (3-D) point projected onto a point tracking virtual camera in each of the N input frames and v ∈{0, 1} denotes its visibility.

It is noted that one or more of plurality of point tracks 238 may be obtained, in action 362, by being determined using optional point tracker software 216 of video frame interpolation software code 110/210, executed by the hardware processor 104 of system 100, or by being received as an input from system user 136, by video frame interpolation software code 110/210, executed by the hardware processor 104 of system 100. It is further noted that plurality of point tracks 238 may include linear point tracks, non-linear point tracks, or one or more linear point tracks and one or more non-linear point tracks. Moreover, although in some use cases plurality of point tracks 238 may extend from first video frame 132/232 to second video frame 134/234, i.e., pass through both first video frame 132/232 and second video frame 134/234, that is not a requirement. In some other use cases, system user 136 may designate that one or more of plurality of point tracks 238 does not pass through both first video frame 132/232 and second video frame 134/234. For example, in one use case, system user 136 may specify that one or more of plurality of point tracks 238 extends from first video frame 132/232 toward second video frame 134/234 but misses second video frame 134/234. Alternatively, or in addition, system user 136 may specify that one or more of plurality of point tracks 238 does not pass through first video frame 132/232 but extends past first video frame 132/232 to pass through second video frame 134/234.

With respect to the order of actions 361 and 362 depicted in FIG. 3, it is noted that although flowchart 360 lists action 361 before action 362, that representation is merely exemplary. In various implementations of the method outlined by flowchart 360, action 362 may precede action 361, may follow action 361, or may be performed in parallel with, i.e., contemporaneously with, action 361.

Continuing to refer to FIGS. 1, 2 and 3 in combination, flowchart 360 further includes identifying a target position for interpolated video frame 150/250 between first video frame 132/232 and second video frame 134/234 (action 363). Two specific use cases can be distinguished. In the more general use case, the target position for interpolated video frame 150/250 is completely unknown. In that case the target position on each of plurality of point tracks 238 can be interpolated using any known discrete point interpolation method. It is noted that because a point can be tracked through the entirety of input video sequence 130a/230a, higher order interpolation methods such as cubic splines can be used. Moreover, in some use cases the trajectories of one or more of plurality of point tracks 238 can be adjusted by system user 136. For example, and as noted above, system user 136 may adjust one or more of plurality of point tracks 238 to be linear, non-linear, or to have respective trajectories that do not pass through one of first video frame 132/232 or second video frame 134/234.

In the second use case, the target position for interpolated video frame 150/250 is known and the true positions on plurality of point tracks 238 can be extracted. This second case allows for interpolation of frames aligned with first video frame 132/232 and second video frame 134/234, which can be used during training to train with a better supervision signal, or during evaluation to avoid comparing misaligned frames. Identification of the target position for interpolated video frame 150/250, in action 363, may be performed by video frame interpolation software code 110/210, executed by hardware processor 104 of system 100.

Continuing to refer to FIGS. 1, 2 and 3 in combination, flowchart 360 further includes determining, using plurality of point tracks 238, a first optical flow between the target position identified in action 363 and first video frame 132/232, and a second optical flow between the target position and second video frame 134/234 (action 364). It is noted that, in some implementations, the first optical flow determined in action 364 may be from the target position identified in action 363 to first video frame 132/232, and the second optical flow determined in action 364 may be from the target position identified in action 363 to second video frame 134/234. However, in other implementations, the first optical flow determined in action 364 may be from first video frame 132/232 to the target position identified in action 363, and the second optical flow determined in action 364 may be from second video frame 134/234 to the target position identified in action 363.

It is further noted that the optical flow, i.e.,

$${F}_{t \to i}^{0} ,$$

to video frame i at pixel y can be defined as:

$${F}_{t \to i}^{0} [ y ] = {P}_{i}^{{l}^{*}} - {P}_{t}^{{l}^{*}} , {l}^{*} = \begin{matrix}arg min \\ l ∈ \{ 1 … L \vert {v}_{t}^{j} \}\end{matrix} \vert {P}_{t}^{l} - y \vert \qquad ( Equation 1 )$$

The determination of the first and second optical flows, in action 364, may be performed by video frame interpolation software code 110, executed by hardware processor 104 of system 100.

Continuing to refer to FIGS. 1, 2 and 3 in combination, flowchart 360 further includes warping, using the first optical flow and the second optical flow determined in action 364, respectively, first video frame 132/232 and second video frame 134/234, respectively (action 365). It is noted that in implementations in which the first and second optical flows determined in action 364 are from the target position identified in action 363 to first video frame 132/232 and second video frame 134/234, respectively, the warping performed in action 365 may be a backward warping of first video frame 132/232 and second video frame 134/234 using the first optical flow and the second optical flow, respectively. Alternatively, in implementations in which the first and second optical flows determined in action 364 are from respective first video frame 132/232 and second video frame 134/234 to the target position identified in action 363, the warping performed in action 365 may be a forward warping of first video frame 132/232 and second video frame 134/234 using the first optical flow and the second optical flow, respectively. The warping of first video frame 132/232 and second video frame 134/234, in action 365, may be performed by video frame interpolation software code 110/210, executed by hardware processor 104 of system 100.

In some implementations, prior to the warping of first video frame 132/232 and second video frame 134/234 performed in action 365, hardware processor 104 of system 100 may execute video frame interpolation software code 110/210 to refine the first optical flow and the second optical flow determined in action 364 to provide a refined first optical flow and a refined second optical flow. In some of those implementations, the first optical flow and the second optical flow may be refined over one or more refinement iterations at one fourth (¼) resolution, for instance.

For example, the initial optical flows determined in action 364,

$${F}_{t \to \{ 0 , 1 \}}^{0} ,$$

may be refined over K iterations into the final refined optical flows

$${F}_{t \to \{ 0 , 1 \}}^{K} .$$

In order to refine the optical flows at an unknown frame Iₜ it is necessary to solve the interpolation and optical flow problems concurrently. To do so, multi-level scale-agnostic feature pyramids of first video frame 132/232 and second video frame 134/234 are computed. Merely by way of example, in one implementation 5-level scale-agnostic feature pyramids of first video frame 132/232 and second video frame 134/234 may be computed and the bottom 3 levels of scale (¼ . . . 1/16) may be backward warped with the current flow estimates

$${F}_{t \to \{ 0 , 1 \}}^{K}$$

and concatenated with the hidden state hᵢ₋₁, to be initialized as a learnable vector, and may be processed with a DenseNet, for example, as known in the art, shared between the levels. The dense features may then be processed with synthesis GridNet 240 to obtain intermediate outputs h′ on each level of scale. The top level output can be used to compute optical flow residuals with a single convolution, while every level independently updates the hidden state as:

$${h}_{i} = {G}_{σ} ( {h}^{′} ) \cdot {h}_{i - 1} + ( 1 - {G}_{σ} ( {h}^{′} ) ) \cdot {H}_{tan h} ( {h}^{′} ) \qquad ( Equation 2 )$$

where G_{σ}, Hₜₐₙₕ are per-level ConvGRU update gate and output functions.

It is noted that in implementations in which the first optical flow and the second optical flow determined in action 364 are refined to provide a refined first optical flow and a refined second optical flow, it is those refined first and second optical flows, respectively that are used to warp first video frame 132/232 and second video frame 134/234, respectively, in action 365.

Continuing to refer to FIGS. 1, 2 and 3 in combination, flowchart 360 further includes predicting, using video frame interpolation ML model 212, the warped first video frame produced in action 365 and the warped second video frame produced in action 365, interpolated video frame 150/250 (action 366). For example, a pair of regular feature pyramids may be constructed and the warped inputs may be fed into synthesis GridNet 240, which directly predicts interpolated video frame 150/250. In implementations in which a refined first optical flow and a refined second optical flow are provided, the final hidden state of the flow refinement may be provided by concatenating that hidden state with warped features, at ¼ resolution for example.

With respect to the order of actions 365 and 366 depicted in FIG. 3, it is noted that although flowchart 360 lists action 365 before action 365, that representation is merely exemplary. In some implementations of the method outlined by flowchart 360, action 366 may be performed in parallel with, i.e., contemporaneously with, action 365.

It is further noted that the warping performed in action 365 may suffer from ghosting artifacts when multiple target regions are sampled from the same source region, due to occlusions. Two independent methods for mitigation of such artifacts are disclosed herein: (1) input masking and (2) occlusion score.

Input Masking: Typically in the regions where ghosting artifacts are present the other warp contains good information. While it is difficult for video frame interpolation ML model 212 to predict which of first video frame 132/232 or second video frame 134/245 should be used, it is often a trivial task for a human user, such as system user 136. Video frame interpolation ML model 212 can be conditioned to handle user specified masks by extending the training of video frame interpolation ML model 212 to randomly generate a mask and erase information in one of the input video frames. Thus, in some implementations, a portion of at least one of first video frame 132/232 or second video frame 134/234 may be masked during the warping performed in action 365, and that masking may be specified by system user 136.

Occlusion Score: In order to enable video frame interpolation ML model 212 to automate estimation of occluded regions without input from system user 136, a computation as to whether an object in first video frame 132/232 and/or second video frame 134/234 is occluded may be performed. First, two weight maps W can be extracted from the final hidden flow state h_{K}. Those weight maps may then be used to evaluate the contribution of each pixel if it was splat to first video frame 132/232 and/or second video frame 134/234, compared to all other pixels. More formally, at target frame pixel y occlusion mask oᵢ for i-th keyframe is defined as:

$$o [ y ] = {W}_{i} [ y ] \cdot {( {\sum }_{x ∈ Ω} d ( x , y ) \cdot {W}_{i} [ y ] )}^{- 1} \qquad ( Equation 3 a )$$

$$d ( x , y ) = \{ \begin{matrix}1 , & if \vert ( x + {F}_{t \to i}^{K} [ x ] ) - ( y + {F}_{t \to i}^{K} [ y ] ) < 1 \vert \\ 0 , & otherwise\end{matrix} \qquad ( Equation 3 a )$$

where d (x, y) indicates if two pixels are splat to the same target at the input video frame. Occlusion masks may then be concatenated with the inputs to synthesis GridNet 240, at ¼ resolution for example.

Thus, in some implementations, a portion of at least one of first video frame 132/232 or second video frame 134/234 may be masked during the warping performed in action 365, and that masking may be determined by video frame interpolation software code 110/210, executed by hardware processor 104 of system 100.

Conventional interpolation methods are typically trained on frame triplets with supervision available only for t=0.5. However, if a synthesis network is not conditioned on the timestep t, the optimal output is the average of the illumination of first video frame 132/232 and second video frame 134/234, which can cause discontinuous appearance when transitioning between input video frame pairs. Nevertheless, it is difficult to naively timestep-condition the network with only a single non-degenerate case.

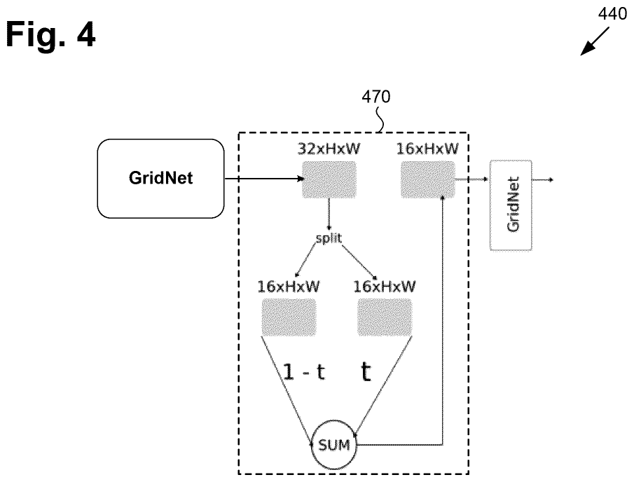

The present approach addresses the issue of timestep awareness by treating the appearance weighting as a controllable parameter and splitting an intermediate synthesis network layer into two parts with an objective that each part learns to reconstruct the interpolated frame with appearance corresponding to one of first video frame 132/232 or second video frame 134/234, respectively. The channels can then be linearly blended given an adjustable t_{blend} parameter, which can typically be set to the target position of interpolated video frame 150/250, i.e., t. The blended features can be further refined with the rest of synthesis GridNet 240. A visual depiction of this approach is shown in FIG. 4 where synthesis GridNet 440 is shown to include timestep-aware synthesis network 470. Synthesis GridNet 440 corresponds in general to synthesis GridNet 240, in FIG. 2, and each of those corresponding features may share any of the characteristics attributed to either of those corresponding features by the present disclosure. Thus, although not shown in FIG. 2, like synthesis GridNet 440, synthesis GridNet 240 may include timestep-aware synthesis network 470.

In order to encourage timestep-aware synthesis network 470 to perform a split based on the appearance, degenerate training triplets may be generated with t=0.001 or t=0.999 and the network may be tasked with reconstructing the respective input video frames during ten percent of training, for example, or any other desired fraction of training. Because illumination change can be non-linear, in order to provide an improved training signal, a scalar t_{blend} can be estimated as:

$${t}_{blend} = \begin{matrix}arg max \\ t ∈ ( 0 , 1 )\end{matrix} \sum {\vert ( t \cdot {X}_{0} + ( 1 - t ) \cdot {X}_{1} ) - E ( {I}_{t} ) \vert}_{2}^{2} \qquad ( Equation 4 )$$

where X₀ and X₁ are the split feature channels, and E (Iₜ) are learned extracted features from the ground truth. Thus, in some implementations, predicting the interpolated video frame, in action 366, uses a weighted combination of the warped first video frame and the warped second video frame. Moreover, and referring to FIGS. 1 and 2, the respective weights used to combine the warped first video frame with the warped second video frame may be determined, by video frame interpolation software code 110/210 executed by hardware processor 104 of system 100, based on the target position for interpolated video frame 150/250 identified in action 363.

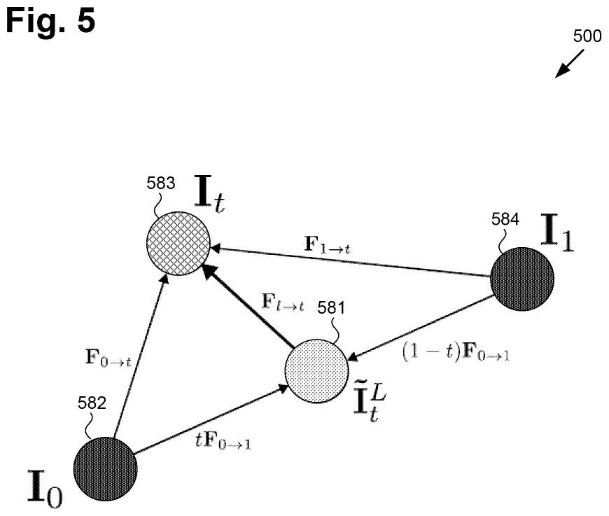

It is noted that although video sequences often depict non-linear motion, the only motion that can be estimated from a two frame input is linear motion. As shown by diagram 500 in FIG. 5, that constraint can result in misalignment between predicted video frame 581 and reference video frame 583 during training, resulting in an incorrect supervision signal, as well as during evaluation when testing is done against images following different motion paths. Also shown in FIG. 5 are first training video frame 582 and second training video frame 584. It is noted that predicted video frame 581 is an interpolated video frame between first training video frame 582 and second training video frame 584 based on linear motion estimation, while reference video frame 583 is the actual video frame between first training video frame 582 and second training video frame 584 in a video sequence that includes non-linear motion between first training video frame 582, reference video frame 583 and second training video frame 584.

Referring to FIGS. 2 and 5 in combination, the present video frame interpolation solution mitigates the misalignment depicted in FIG. 5 by computing offset vectors to reference video frame 583 and providing those offset vectors to video frame interpolation ML model 212, thus enabling video frame interpolation ML model 212 to reconstruct the correct position for the interpolated video frame, i.e., the position occupied by reference video frame 583 in FIG. 5. First, the motion between first training video frame 582 and second training video frame 584 is computed, as is the motion between each of first training video frame 582, second training video frame 584 and reference video frame 583. Next, the misalignment offsets ok at the training video frame k ∈{0,1} are computed as:

$${o}_{k} = {F}_{k \to t} - t \cdot {F}_{k \to 0} \qquad ( Equation 5 )$$

By a simple term cancellation, adding the offset values directly to the optical flows would provide the correct motion, but that process is prone to error because it is possible that the offsets for first training video frame 582 and second training video frame 584 do not match, e.g. in the case when extracting quadratic motion from three consecutive video frames. Consequently, the computed offsets may be warped to the linear target position and a single offset representation of that offset Ft-t can be constructed and then backward warped to the positions of first training video frame 582 and second training video frame 584, so that both first training video frame 582 and second training video frame 584 follow the same non-linear motion. Thus, referring to FIGS. 1 and 2, video frame interpolation ML model 212 may be trained to predict non-linear motion between first video frame 132/232 and second video frame 134/234. Iₜ is noted that providing these offset vectors additionally and advantageously enable the use of higher-order motion models while only training on triplets.

With respect to sharpness and detail control of interpolated video frame 150/250, in FIGS. 1 and 2, it is noted that training with pixel losses alone can yield blurry results. Although the motion-aligned training disclosed in the present application and described above improves the perceptual quality of interpolated video frames, perceptual losses can improve that perceptual quality even further. This may be achieved by tuning the weights of video frame interpolation ML model 212 based on low-rank adaption. To that end, video frame interpolation ML model 212 is first trained without any perceptual losses and then only the low rank updates are fine tuned for each convolution of the lateral blocks of synthesis GridNet 240. The output of each convolution is redefined to:

$$y = Φ ( x ) + w \cdot {Φ}_{lr} ( x ) \qquad ( Equation 6 )$$

where x is the input, Φ is the original layer that is frozen and Φₗᵣ is a low-rank convolution that is fine-tuned and initialized to return zeros, while w is the control weight that is uniformly sampled during training w˜ [symbol] _{[0,1]} and is applied to the loss scaling as well.

For a single variable, weight interpolation may be used to learn two full-rank endpoints of the weights and interpolate between them, while low rank adaptation can be seen as learning a direction to a low-rank updated state.

It is noted that in practice, control for more than one variable can be added (e.g., for feature loss and style loss separately) by using more than one low-rank addition:

$$y = Φ ( x ) + {w}_{vgg} \cdot {Φ}_{lr} ( x ) + {w}_{style} \cdot {Φ}_{lr}^{′} ( x ) . \qquad ( Equation 7 )$$

Thus, the present application discloses systems and methods for performing controllable video frame interpolation with latent blending and motion alignment that address and overcome the deficiencies in the conventional art. As stated above, the disclosure provided in the present application connects point tracking with non-linear motion estimation and motion controllability to introduce a novel and inventive tracking-based video frame interpolation system and method. In addition, a plurality of augmentation techniques are disclosed herein that can be applied to the present video fame interpolation solution, as well as to conventional video frame interpolation methods. Those augmentation techniques may be used to improve the training performed in conventional video frame interpolation methods, to add elements of control making those conventional methods more usable for practical applications in the industry, and to enable the analysis of non-linearities that are present in the commonly used datasets and address the impact those non-linearities have when training is performed on uncurated video data.

As further stated above, the video frame interpolation solution disclosed by the present application advances the state-of-the-art in several ways. For example, the present video frame interpolation approach is a tracking-based interpolation approach that utilizes sparse correspondences between video frames and performs timestep-dependent frame blending to control how much the appearance of each input video frame affects the interpolated video frame. In addition, motion-aligned training adjusts a ML model to better handle non-linear motion in the training data, resulting in improvement in the sharpness of the interpolated video frames and the ability of the trained ML model to perform non-linear motion interpolation while training only with frame triplets. Further advantages include low-rank synthesis adaptation that enables sharpness adjustment during inference and also enables spatially-variable user control, the use of user-specified keyframe correspondences that allow a system user to assist the motion estimation ML model by providing it with correct matches, and enabling user control for specifying motion curves thereby allowing system users to control where objects appear in the interpolated video frame.

From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described herein, but many rearrangements, modifications, and substitutions are possible without departing from the scope of the present disclosure.

What is claimed is:

1. A system comprising:
a hardware processor; and
a system memory storing a software code including a video frame interpolation machine-learning (ML) model;
the hardware processor configured to execute the software code to:
receive an input video sequence including at least a first video frame and a second video frame;
obtain a plurality of point tracks between the first video frame and the second video frame;
identify a target position for an interpolated video frame between the first video frame and the second video frame;
determine, using the plurality of point tracks, a first optical flow between the target position and the first video frame, and a second optical flow between the target position and the second video frame;
warp, using the first optical flow and the second optical flow, respectively, the first video frame and the second video frame, respectively; and
predict, using the video frame interpolation ML model, the warped first video frame and the warped second video frame, the interpolated video frame.

2. The system of claim 1, wherein each of the plurality of point tracks is a sparse point track.

3. The system of claim 1, wherein at least one of the plurality of point tracks is obtained by being determined using the software code, executed by the hardware processor, or by being received as an input from a system user.

4. The system of claim 1, wherein prior to warping, each of the first optical flow and the second optical flow is refined at one fourth (¼) resolution to provide a refined first optical flow and a refined second optical flow, and wherein warping the first video frame and the second video frame comprises warping the first video frame and the second video frame using the refined first optical flow and the refined second optical flow, respectively.

5. The system of claim 1, wherein the first optical flow is from the target position to the first video frame and the second optical flow is from the target position to the second video frame, and wherein warping the first video frame and the second video frame comprises backward warping the first video frame and the second video frame using the first optical flow and the second optical flow, respectively.

6. The system of claim 1, wherein the first optical flow is from the first video frame to the target position and the second optical flow is from the second video frame to the target position, and wherein warping the first video frame and the second video frame comprises forward warping the first video frame and the second video frame using the first optical flow and the second optical flow, respectively.

7. The system of claim 1, wherein a portion of at least one of the first video frame or the second video frame is masked during the warping, and wherein the portion of the at least one of the first video frame or the second video frame is masked as specified by a system user, or as determined by the software code executed by the hardware processor.

8. The system of claim 1, wherein predicting the interpolated video frame uses a weighted combination of the warped first video frame and the warped second video frame.

9. The system of claim 8, wherein the hardware processor is further configured to execute the software code to:
determine respective weights used to combine the warped first video frame with the warped second video frame based on the target position for the interpolated video frame.

10. The system of claim 1, wherein the video frame interpolation ML model is trained to predict non-linear motion between the first video frame and the second video frame.

11. A method for use by a system including a hardware processor and a system memory storing a software code including a video frame interpolation machine learning (ML) model, the method comprising:
receiving, by the software code executed by the hardware processor, an input video sequence including at least a first video frame and a second video frame;
obtaining, by the software code executed by the hardware processor, a plurality of point tracks between the first video frame and the second video frame;
identifying, by the software code executed by the hardware processor, a target position for an interpolated video frame between the first video frame and the second video frame;
determining, by the software code executed by the hardware processor and using the plurality of point tracks, a first optical flow between the target position and the first video frame, and a second optical flow between the target position and the second video frame;
warping, by the software code executed by the hardware processor and using the first optical flow and the second optical flow, respectively, the first video frame and the second video frame, respectively; and
predicting, by the software code executed by the hardware processor and using the video frame interpolation ML model, the warped first video frame and the warped second video frame, the interpolated video frame.

12. The method of claim 11, wherein each of the plurality of point tracks is a sparse point track.

13. The method of claim 11, wherein obtaining at least one of the plurality of point tracks comprises determining, by the software code executed by the hardware processor, the at least one of the plurality of point tracks, or receiving the at least one of the plurality of point tracks as an input from a system user.

14. The method of claim 11, the method further comprising:
prior to warping the first optical flow and the second optical flow, refining, by the software code executed by the hardware processor, each of the first optical flow and the second optical flow at one fourth (¼) resolution to provide a refined first optical flow and a refined second optical flow; and
wherein warping the first video frame and the second video frame comprises warping the first video frame and the second video frame using the refined first optical flow and the refined second optical flow, respectively.

15. The method of claim 11, wherein the first optical flow is from the target position to the first video frame and the second optical flow is from the target position to the second video frame, and wherein warping the first video frame and the second video frame comprises backward warping the first video frame and the second video frame using the first optical flow and the second optical flow, respectively.

16. The method of claim 11, wherein the first optical flow is from the first video frame to the target position and the second optical flow is from the second video frame to the target position, and wherein warping the first video frame and the second video frame comprises forward warping the first video frame and the second video frame using the first optical flow and the second optical flow, respectively.

17. The method of claim 11, wherein a portion of at least one of the first video frame or the second video frame is masked during the warping, and wherein the portion of the at least one of the first video frame or the second video frame is masked as specified by a system user, or as determined by the software code executed by the hardware processor.

18. The method of claim 11, wherein predicting the interpolated video frame uses a weighted combination of the warped first video frame and the warped second video frame.

19. The method of claim 18, wherein respective weights used to combine the warped first video frame with the warped second video frame are determined, by the software code executed by the hardware processor, based on the target position for the interpolated video frame.

20. The method of claim 11, wherein the video frame interpolation ML model is trained to predict non-linear motion between the first video frame and the second video frame.
